(19) United States
(12) Patent Application Publication
(10) Pub. No.: US 2008/0203620 A1
(43) Pub. Date: Aug. 28, 2008

(54) METHOD OF FORMING MINUTE PATTERN

(75) Inventors: Motoki Okinaka, Saitama (JP); Kazuhito Tsukagoshi, Saitama (JP); Yoshinobu Aoyagi, Saitama (JP); Hiroshi Tsushima, Osaka (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: RIKEN, Wako-shi (JP); NIPPON PAINT CO., LTD, Osaka (JP)

(21) Appl. No.: 11/845,618

(22) Filed: Aug. 27, 2007

(30) Foreign Application Priority Data
Feb. 27, 2007 (JP) 2007-046968

(51) Int. Cl. B29C 35/08

(52) U.S. Cl. 264/483; 264/488

(57) ABSTRACT

There is provided a method for forming minute patterns ranging from nanometer scale to micrometer scale with high aspect ratio at one time under a single condition of low temperature, low pressure, and a short period of time. A method of forming a minute pattern according to the present invention includes: applying, onto a substrate, a patterning material containing a polysilane and a silicone compound; pressing a mold on which a predetermined minute pattern has been formed to the patterning material which has been applied onto the substrate; irradiating energy rays from a side of the substrate while the mold is contacted by press with the patterning material; releasing the mold; and irradiating the patterning material with energy rays from a side to which the mold has been pressed.

This application claims priority under 35 U.S.C. Section 119 to Japanese Patent Application No. 2007-46968 filed on Feb. 27, 2007, which is herein incorporated by reference.

### BACKGROUND OF THE INVENTION

1. Field of the Invention

The present invention relates to a method of forming a minute pattern. More specifically, the present invention relates to a method of forming, at one time, minute patterns ranging from nanometer scale to micrometer scale with high aspect ratios under a condition of low temperature, low pressure and a short period of time.

2. Description of the Related Art

A nanoimprint technology is known as a technique for forming minute pattern with a minute concavo-convex structure on a nanometer (nm) scale. A typical procedure for forming a pattern using a nanoimprint technology is as follows: (1) applying a patterning material to a substrate; (2) pressing, onto the patterning material, a mold on which a predetermined minute pattern with a concavo-convex structure has been formed with a predetermined pressure, and promoting thermal deformation by heat treatment or ultraviolet curing by irradiation of ultraviolet rays; and (3) releasing the mold from the patterning material after a predetermined time for reversely transferring the minute pattern formed on the mold to the patterning material. The pattern formation by the nanoimprint technology has the following advantages as compared with the photolithographic technology supporting the present semiconductor technologies: (i) the principle of the nanoimprint technology is simple and the process thereof is speedy; (ii) the nanoimprint technology is environmentally friendly because of requiring no wet process using an organic solvent; and (iii) the nanoimprint technology can be performed with a much less expensive device compared with a stepper for use in photolithography.

Conventionally, in the nanoimprint technology, a patterning material made of an organic material (e.g., PMMA) to which a pattern of a mold is easy to be transferred has been used. However, an organic material has disadvantages in that the organic material is easy to absorb moisture; the heat resistance and chemical resistance are insufficient; and the hardness is relatively low. As a result, a film having a minute pattern formed using a patterning material made of an organic material has a problem in that the use conditions are limited to a very narrow range.

In order to solve the above-mentioned problems, a technology using a patterning material made of an inorganic material is proposed in, for example, the following documents:

“Nanoimprint of Glass Materials with Glass Carbon Molds Fabricated by Focused-Ion-Beam Etching”, Masaharu Tkahashi, Koichi Sugimoto and Ryutaro Maeda, Jpn. J. Appl. Phys., 44,5600 (2005). and

“Large are direct nanoimprinting of Si02-Ti02 gel gratings for optical applications”, Mingtao Li, Hua Tan, Lei Chen, Jian Wang, and Stephen Y. Chou, J. Vac. Sci. Technol. B 21 660 (2003).

However, because an inorganic material has high melting point and is particularly hard at normal temperature, an in organic material has a problem in that the pattern formation must be performed at high temperature and at high pressure over a long period of time. As a result, there is a problem in that a heavy load is applied onto a nanoimprint device and a mold, and that they are damaged or broken down easily. Further, because a high temperature processing is performed as described above, the formed minute pattern expands or contracts due to temperature changes, resulting in a problem that the formed minute pattern is easy to deform. In addition, the conventional technology using an inorganic material as a patterning material has a problem in that a minute pattern with a high aspect ratio is difficult to form.

### SUMMARY OF THE INVENTION

The present invention has been made in order to solve the above-mentioned conventional problems, and it is therefore an object of the present invention to provide a method for forming minute patterns ranging from nanometer scale to micrometer scale with high aspect ratio at one time under a condition of low temperature, low pressure, and a short period of time.

A method of forming a minute pattern according to an embodiment of the present invention includes: applying, onto a substrate, a patterning material containing a polysilane and a silicone compound; pressing a mold on which a predetermined minute pattern has been formed to the patterning material which has been applied onto the substrate; irradiating energy rays from a side of the substrate while the mold is contacted by press with the patterning material; releasing the mold; and irradiating the patterning material with energy rays from a side to which the mold has been pressed.

In one embodiment of the invention, the method further includes irradiating oxygen plasma after the mold has been released.

In another embodiment of the invention, the pressing is performed at around room temperature.

In still another embodiment of the invention, the pressing is performed with a pressure of 1 to 3 MPa.

In still another embodiment of the invention, the method further includes heating the patterning material after irradiating the energy rays from the side to which the mold has been pressed.

In still another embodiment of the invention, the heating is performed at 150 to 450° C.

In still another embodiment of the invention, the patterning material has an application thickness larger than a height of the minute pattern formed on the mold.

In still another embodiment of the invention, the method further includes heating the patterning material before the pressing.

In still another embodiment of the invention, the energy rays include ultraviolet rays.

In still another embodiment of the invention, the irradiation of energy rays from the side to which the mold has been pressed is performed in the presence of ozone.

In still another embodiment of the invention, the patterning material contains the polysilane and the silicone compound at a weight ratio of 80:20 to 5:95.

In still another embodiment of the invention, the polysilane includes a branched polysilane.

In still another embodiment of the invention, the branched polysilane has a degree of branch of 2% or higher.

In still another embodiment of the invention, the patterning material further contains a sensitizer.

According to another aspect of the invention, a three-dimensional photonic crystal is provided. The three-dimensional photonic crystal includes a minute pattern formed by the above-described method.

According to still another aspect of the invention, a biochip is provided. The biochip includes a minute pattern formed by the above-described method.

According to still another aspect of the invention, a patterned media is provided. The patterned media includes a minute pattern formed by the above-described method.

According to the present invention, nanoimprinting of a glass material can be performed at low temperature, at low pressure, and in a short period of time by using a patterning material including a polysilane and a silicone compound and by irradiation with energy rays by a specific procedure. As a result, a nanoimprint processing time can be greatly shortened compared with a processing time of the conventional process for a glass material. Further, because the process is performed at low temperature, expansion and contraction of a minute pattern due to temperature changes are diminished to such an extent that expansion and contraction can be ignored. Therefore, deformation of a minute pattern to be formed can be notably favorably avoided. In addition, a minute pattern with excellent heat resistance, mechanical properties, light transmittance, and chemical resistance can be obtained. In addition, because a starting material is a relatively soft polymer material, a minute pattern with higher aspect ratio can be obtained as compared with a case where a hard glass material is imprinted as it is.

### BRIEF DESCRIPTION OF THE DRAWINGS

In the accompanying drawings:

FIGS. 1A to 1E schematically illustrate a procedure of a method of forming a minute pattern according to a preferred embodiment of the present invention;

FIGS. 2A to 2D schematically illustrate a chemical change of polysilane incorporated in a patterning material in the method of forming a minute pattern according to the preferred embodiment of the present invention; and

FIG. 3A is an SEM photograph of a minute pattern of a mold used in an example of the present invention, and FIG. 3B is an SEM photograph of a minute pattern obtained in the example of the present invention.

### DETAILED DESCRIPTION OF THE PREFERRED EMBODIMENTS

Hereinafter, a patterning material used in the present invention will be described. Then, a specific procedure of a method of forming a minute pattern will be described.

### A. PATTERNING MATERIAL

A patterning material for use in the present invention includes a polysilane and a silicone compound. Generally, the patterning material further includes a solvent. The patterning material may optionally contain a suitable additive depending on the purpose. Typical examples of the additive include a sensitizer, and a surface active agent.

### A-1. Polysilane

In this specification, the term “polysilane” refers to a polymer having a main chain consisting of only silicon atoms. The polysilane used in the present invention may be a straight chain type or a branched type. A branched polysilane is preferable. This is because the branched polysilane is excellent in solubility and compatibility with respect to a solvent or a silicone compound, and is also excellent in a film formation property. Polysilanes are classified into branched polysilanes and straight chain polysilanes depending on the bonding state of Si atoms incorporated in polysilanes. The branched polysilane refers to a polysilane which includes Si atoms in which the number of bonding to adjacent Si atoms is 3 or 4. In contrast, in a straight chain polysilane, the number of bonding in Si atoms is 2. Considering the fact that the valence of an Si atom is usually 4, the Si atoms whose bonding number is three or less among the Si atoms present in such a polysilane are bonded to a hydrogen atom or an organic substituent such as a hydrocarbon group and an alkoxy group in addition to an Si atom. Specific examples of preferable hydrocarbon groups include C₁₋₁₀ hydrocarbon groups which may be substituted with halogen and C₆₋₁₄ aromatic hydrocarbon groups which may be substituted with halogen. Specific examples of hydrocarbon groups include substituted or unsubstituted aliphatic hydrocarbon groups, such as a methyl group, an ethyl group, a propyl group, a butyl group, a hexyl group, an octyl group, a decyl group, a trifluoropropyl group, and a nonafluorohexyl group, and alicyclic hydrocarbon groups such as a cyclohexyl group and a methyl cyclohexyl group. Specific examples of aromatic hydrocarbon groups include a phenyl group, a p-tolyl group, a biphenyl group, and an anthracenyl group. Examples of an alkoxy group include C₁₋₈ alkoxy groups. Specific examples of C₁₋₈ alkoxy groups include a methoxy group, an ethoxy group, a phenoxy group, and an octyloxy group. Of those, in view of easiness in synthesis, a methyl group and a phenyl group are particularly preferable. For example, polymethylphenylsilane, polydimethylsilane, polydiphenylsilane, and a copolymer thereof can be preferably used. For example, the refractive index of a pattern or an optical element to be obtained can be adjusted by changing the structure of polysilane. Specifically, when a high refractive index is desired, a large amount of diphenyl groups may be incorporated during copolymerization, and when a low refractive index is desired, a large amount of dimethyl groups may be incorporated during copolymerization.

In branched polysilanes, the degree of branch is preferably 2% or more, more preferably 5 to 40%, and particularly preferably 10 to 30%. When the degree of branch is less than 2%, the solubility is low and microcrystals, which are likely to be generated in a film to be obtained, cause scattering, resulting in insufficient transparency in many cases. When the degree of branch is excessively high, polymerization of a polymer having large molecular weight may become difficult, and absorption in a visible region may become large due to the branching. In the above-mentioned preferable range, optical transmittance can be increased as the degree of branch is higher. In this specification, the phrase “the degree of branch” refers to a proportion of the Si atoms whose bonding number with adjacent Si atoms is 3 or 4 in all Si atoms of a branched polysilane. In this specification, for example, the phrase “the bonding number with adjacent Si atoms is 3” refers to a case where three bonding hands of an Si atom are bonded to Si atoms.

The polysilane used in the present invention can be produced by a polycondensation reaction in which a halogenated silane compound is heated to 80° C. or higher in an organic solvent such as n-decane or toluene in the presence of an alkaline metal such as sodium. Moreover, the polysilane used in the present invention can also be synthesized by an electrolytic polymerization method or a method using magnesium metal and metal chloride.

A branched polysilane is obtained by heating a halosilane mixture including an organotrihalosilane compound, a tetrahalosilane compound, and a diorganodihalosilane compound for polycondensation. The degree of branch of a branched polysilane can be controlled by adjusting the amount of the organotrihalosilane compound and the tetrahalosilane compound in the halosilane mixture. For example, by the use of a halosilane mixture in which the proportion of an organotrihalosilane compound and a tetrahalosilane compound is 2 mol % or more with respect to the total amount, a branched polysilane whose degree of branch is 2% or more can be obtained. In such a case, an organotrihalosilane compound serves as a source of an Si atom whose bonding number with adjacent Si atoms is 3, and a tetrahalosilane compound serves as a source of an Si atom whose bonding number with adjacent Si atoms is 4. The branch structure of a branched polysilane can be confirmed by measuring an ultraviolet absorption spectrum or the nuclear magnetic resonance spectrum of silicon.

The halogen atom of each of the above-mentioned organotrihalosilane compound, tetrahalosilane compound, and diorganodihalosilane compound is preferably a chlorine atom. Examples of substituents other than the halogen atom of the organotrihalosilane compound and diorganodihalosilane compound include the above-mentioned hydrogen atom, hydrocarbon group, alkoxy group, and functional group.

There is no limitation on the above-mentioned branched polysilane insofar as they are soluble in an organic solvent, compatible with a silicone compound, and form a transparent film when being applied.

The weight average molecular weight of the above-mentioned polysilane is preferably 5,000 to 50,000 and more preferably 10,000 to 20,000.

The above-mentioned polysilane may contain a silane oligomer, if required. The content of silane oligomer in the polysilane is preferably 5 to 25% by weight. By containing a silane oligomer in the above-mentioned range, a press contact process can be performed at lower temperature. When the oligomer content exceeds 25% by weight, flowage and disappearance of a pattern may occur in a heating process.

The weight average molecular weight of the above-mentioned silane oligomer is preferably 200 to 3,000 and more preferably 500 to 1,500.

### A-2. Silicone Compound

As a silicone compound used in the present invention, any appropriate silicone compound which is compatible with a polysilane and an organic solvent and which can form a transparent film can be used. In one embodiment, a silicone compound is a compound represented by the following general formula:

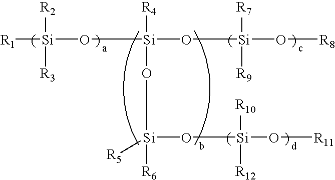

where R₁ to R₁₂ each independently represents C₁₋₁₀ hydrocarbon groups which may be substituted with a halogen or glycidyloxy group, C₆₋₁₂ aromatic hydrocarbon groups which may be substituted with a halogen or glycidyloxy group, or C₁₋₈ alkoxy groups which may be substituted with a halogen or glycidyloxy group, and a, b, c, and d are integers including 0 and satisfy a+b+c+d≧1.

A specific example thereof includes a silicone compound obtained by hydrolysis condensation of two or more kinds of dichlorosilane referred to as a D isomer, which has two organic substituents, and trichlorosilane referred to as T isomers, which has one organic substituent.

Specific examples of the hydrocarbon groups include substituted or unsubstituted aliphatic hydrocarbon groups such as a methyl group, a propyl group, a butyl group, a hexyl group, an octyl group, a decyl group, a trifluoropropyl group, and a glycidyloxypropyl group, and alicyclic hydrocarbon groups such as a cyclohexyl group and a methyl cyclohexyl group. Specific examples of the above-mentioned aromatic hydrocarbon groups include a phenyl group, a p-tolyl group, and a biphenyl group. Specific examples of the above-mentioned alkoxy groups include a methoxy group, an ethoxy group, a phenoxy group, an octyloxy group, and a tert-butoxy group.

The kinds of R₁ to R₁₂ and the values of a, b, c, and d may be appropriately determined depending on the purpose. For example, compatibility can be improved by incorporating, into a silicone compound, a group same as the hydrocarbon group incorporated in a polysilane. Therefore, when using, for example, a phenylmethyl polysilane as a polysilane, it is preferable to use a phenylmethyl silicone compound or a diphenyl silicone compound. Moreover, for example, a silicone compound which has two or more alkoxy groups in one molecule (specifically, a silicone compound in which at least two groups of R₁ to R₁₂ are C₁₋₈ alkoxy groups) can be used as a crosslinking agent. Specific examples of such a silicone compound include a methylphenyl methoxy silicone and phenylmethoxy silicone which include an alkoxy group in a proportion of 15 to 35% by weight. In this case, the content of the alkoxy group can be calculated from the average molecular weight of the silicone compound and the molecular weight of an alkoxy unit.

The weight average molecular weight of the above-mentioned silicone compound is preferably 100 to 10,000, and more preferably 100 to 3,000.

In one embodiment, a silicone compound contains, if required, a double bond-containing silicone compound. The content of the double bond-containing silicone compound in a silicone compound is preferably 20 to 100% by weight, and more preferably 50 to 100% by weight. By using a double bond-containing silicone compound in the above-mentioned range, the reactivity at the time of the irradiation of energy rays is improved, and press contact at lower temperature and processing at lower irradiation can be achieved. Moreover, when the content of a silicone compound is higher than that of a polysilane, flowage and disappearance of a pattern at the time of a heat treatment due to reduced solidity can be prevented.

The weight average molecular weight of the double bond-containing silicone compound is preferably 100 to 10,000, and more preferably 100 to 5,000.

A chemical group providing a double bond in the above-mentioned double bond-containing silicone compound is preferably a vinyl group, an allyl group, an acryloyl group, or a methacryloyl group. For example, among silicone compounds commonly referred to as a silane coupling agent, silicone compounds having a double bond can be used. In this case, the iodine value is preferably 10 to 254. The number of double bonds in one molecule of a silicone compound may be two or more. Such a silicone compound can be used as a crosslinking agent. Specific examples of such a silicone compound include a vinyl group-containing methylphenyl silicone resin which includes 1 to 30% by weight of a double bond.

A commercially available double bond-containing silicone compound can be used as the double bond-containing silicone compound. For example, compounds shown in the following Table 1 can be used.

TABLE 1

| Double | | | | |
|---|---|---|---|---|
| bond | Manufacturer | Tradename | Kind of silicone compound | Mw |
| Vinyl | Shinetsu Silicone | KBM-1003 | Vinyl trimethoxy silane | 148.2 |
| | Shinetsu Silicone | KBE-1003 | Vinyl triethoxy silane | 190.3 |
| | Shinetsu Silicone | KR-2020 | Vinyl group-containing phenylmethyl | 2,900 |
| | | | silicone resin | |
| | Shinetsu Silicone | X-40-2667 | Vinyl group-containing phenylmethyl | 2,600 |
| | | | silicone resin | |
| | Dow Corning Toray | SZ-6300 | Vinyl trimethoxy silane | |
| | Dow Corning Toray | SZ-6075 | Vinyl triacethoxy silane | |
| | Dow Corning Toray | CY52-162 | Vinyl group containing silicone resin | |
| | Dow Corning Toray | CY52-190 | Vinyl group containing silicone resin | |
| | Dow Corning Toray | CY52-276 | Vinyl group containing silicone resin | |
| | Dow Corning Toray | CY52-205 | Vinyl group containing silicone resin | |
| | Dow Corning Toray | SE1885 | Vinyl group containing silicone resin | |
| | Dow Corning Toray | SE1886 | Vinyl group containing silicone resin | |
| | Dow Corning Toray | SR-7010 | Vinyl group-containing phenylmethyl | |
| | | | silicone resin | |
| | GE Toshiba Silicone | TSL8310 | Vinyl trimethoxy silane | |
| | GE Toshiba Silicone | TSL8311 | Vinyl triethoxy silane | |
| | GE Toshiba Silicone | XE5844 | Vinyl group-containing phenylmethyl | |
| | | | silicone resin | |
| Methacryloyl | Shinetsu Silicone | KBM-502 | 3-methacryloxypropylmethyldimethoxy | 232.4 |
| | | | silane | |
| | Shinetsu Silicone | KBM-503 | 3-methacryloxypropyltrimethoxy | 248.4 |
| | | | silane | |
| | Shinetsu Silicone | KBE-502 | 3-methacryloxypropylmethyldiethoxy | 260.4 |
| | | | silane | |
| | Shinetsu Silicone | KBE-503 | 3-methacryloxypropyltriethoxy | 290.4 |
| | | | silane | |
| | GE Toshiba Silicone | SZ-6030 | γ-methacryloxypropyltrimethoxy | |
| | | | silane | |
| | GE Toshiba Silicone | TSL8370 | γ-methacryloxypropyltrimethoxy | |
| | | | silane | |
| | GE Toshiba Silicone | TSL8375 | γ-methacryloxypropylmethyldimethoxy | |
| | | | silane | |
| Acryloyl | Shinetsu Silicone | KBM-5103 | 3-acryloxypropyltrimethoxy silane | 234.3 |

The above-mentioned silicone compound(s) is incorporated in a patterning material in such a manner that the weight ratio of polysilane to silicone compound is preferably 80:20 to 5:95, and more preferably 70:30 to 40:60. By containing the silicone compound(s) in the above-mentioned range, a film which is sufficiently cured (i.e., notably excellent in hardness), which has very few cracks, and which has high transparency can be obtained.

### A-3. Solvent

The above-mentioned patterning material generally contains a solvent. An organic solvent is preferable as a solvent. Preferable organic solvents include C₅₋₁₂ hydrocarbon solvents, halogenated hydrocarbon solvents, and ether solvents. Specific examples of hydrocarbon solvents include: aliphatic solvents such aspentane, hexane, heptane, cyclohexane, n-decane, and n-dodecane; and aromatic solvents such as benzene, toluene, xylene, and methoxy benzene. Specific examples of halogenated hydrocarbon solvents include carbon tetrachloride, chloroform, 1,2-dichloro ethane, dichloromethane, and chlorobenzene. Specific examples of ether solvents include diethyl ether, dibutyl ether, and tetrahydrofuran. The use amount of the solvent is adjusted in such a manner that the polysilane concentration in a patterning material is in the range of 10 to 50% by weight.

### A-4. Sensitizer

Preferably, the above-mentioned patterning material may further contain a sensitizer. A typical example of a sensitizer includes an organic peroxide. Any compounds, which can efficiently incorporate oxygen between an Si—Si bond of a polysilane, can be employed as the organic peroxides. Examples thereof include a peroxyester peroxide and an organic peroxide having a benzophenone structure. More specifically, 3,3′,4,4′-tetra(t-butylperoxycarbonyl)benzophenone (hereinafter, referred to as “BTTB”) is used preferably. Moreover, an organic peroxide acts on a double bond of a double bond-containing silicone compound to promote an addition polymerization reaction between double bonds.

The above-mentioned sensitizer is used in a proportion of preferably 1 to 30 parts by weight, and more preferably 2 to 10 parts by weight with respect to a total amount of 100 parts by weight of the above-mentioned polysilane and silicone compound. By using a sensitizer in the above-mentioned range, oxidation of a polysilane is promoted even under a non-oxidative atmosphere, and a pattern having notably excellent hardness can be formed at low temperatures, low pressures, and in a short period of time.

### A-5. Other Additives

A specific example of the surface active agent includes a fluorine surfactant. A surface active agent may be preferably used in a proportion of 0.01 to 0.5 parts by weight with respect to a total amount of 100 parts by weight of the above-mentioned polysilane and silicone compound. By using the surface active agent, the coating property of a patterning material can be improved.

### B. METHOD OF FORMING A MINUTE PATTERN

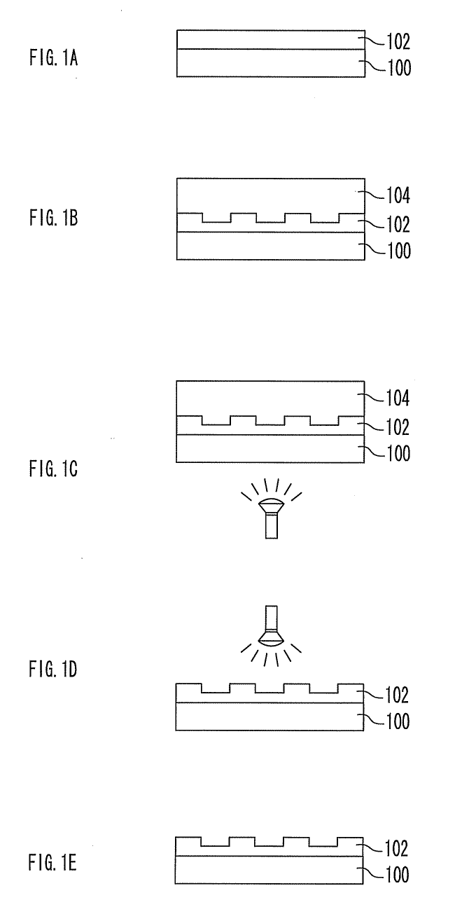

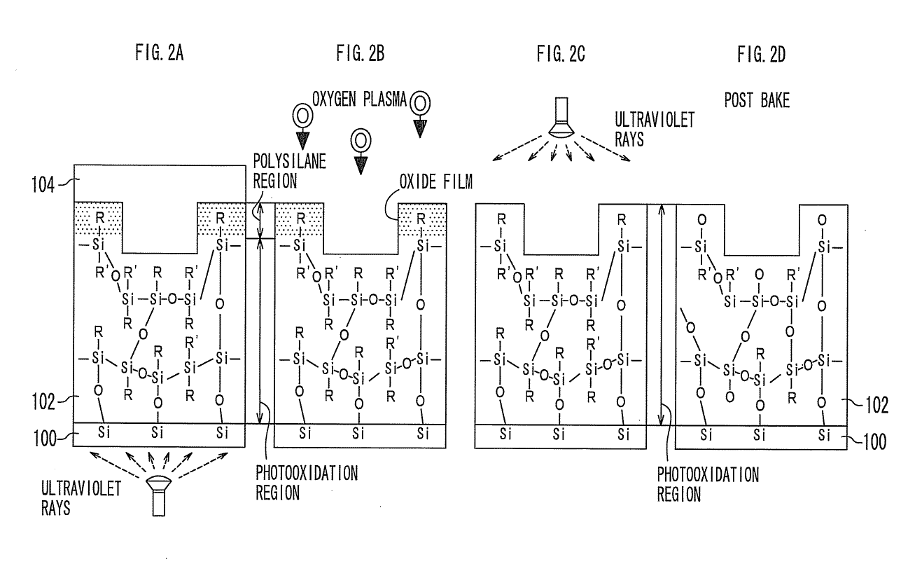

With reference to the drawings, a method of forming a minute pattern according to an embodiment of the present invention will be described. FIGS. 1A to 1E schematically illustrate a procedure of a method of forming a minute pattern according to a preferred embodiment of the present invention. FIGS. 2A to 2D schematically illustrate the chemical change of a polysilane incorporated in a patterning material.

First, as shown in FIG. 1A, a patterning material 102 described in the section A above is applied to a substrate 100. As a substrate, any appropriate substrate through which energy rays can pass may be used. A typical example of a substrate includes a quartz substrate in the case of using ultraviolet rays as energy rays. Any appropriate coating method may be adopted as a method for the coating of a patterning material. Spin coating is mentioned as atypical example. The coating thickness of a patterning material is preferably larger than the height of a minute pattern part of a mold. For example, when the height of the minute pattern part of the mold is 1.0 μm, the coating thickness of the patterning material is preferably about 1.1 to about 2.0 μm. The coating thickness of the patterning material can be controlled by adjusting the concentration of the patterning material and the speed of rotation (rpm) of a spin coater.

Next, as shown in FIG. 1B, a mold 104 on which a predetermined minute pattern has been formed depending on the purpose is contacted by press with the patterning material 102 which has been applied to the substrate 10. Press contact (also referred to as “pressing” in this specification) is preferably performed at about room temperature. Press contact at about room temperature can be achieved by using the above-mentioned patterning material and performing a series of processes to be described later. Because the press contact at about room temperature can minimize a period of time required for raising a temperature and lowering a temperature, processing time of a nanoimprint process (specifically, a pattern transfer process of a mold) can be dramatically reduced. Further, the merit of press contact at about room temperature resides in that because expansion and contraction of the material (e.g., a mold, a substrate, a patterning material and the like) due to temperature changes becomes so small that they can be ignored, thermal deformation of the minute pattern during transferring can be favorably avoided. It is one of the achievements of the present invention that such press contact at about room temperature is realized. In one embodiment, press contact temperature is in the range of room temperature to 80° C., contact pressure is 1 MPa to 3 MPa, and a press contact time is 5 seconds to 15 seconds. According to the present invention, nanoimprint at low temperatures and low pressures, and in a short period of time as described above becomes possible. In the present invention, it is desirable that a patterning material be heat-treated before press contact (a so-called prebaking treatment). As conditions for the prebaking treatment, a heating temperature is 50 to 100° C., and a heating duration is 3 to 7 minutes, for example.

The above-mentioned mold 104 is preferably formed of an energy ray transmittable material, and is more preferably formed of a light transmittable material for alignment of a mold and a lower substrate. A specific example of a material which forms a mold includes quartz glass or an Si substrate having excellent processability.

Next, as shown in FIG. 1C, under a state where the mold 104 and the patterning material 102 are contacted by press, energy rays (typically ultraviolet rays to be described later) are irradiated. As a result, an Si—Si bond in a polysilane in the patterning material is converted into an Si—O—Si bond, thereby vitrifying the patterning material. Energy rays are irradiated from the substrate 100 side. By performing the energy ray irradiation from the substrate 100 side, oxidation (typically photooxidation) of the entire patterning material can be advanced until the mold pattern is firmly fixed as shown in FIG. 2A. Moreover, when using, for example, a quartz substrate, regarding the patterning material in the vicinity of the substrate 100, an Si—O—Si bond is also formed between Si atoms of the substrate and the patterning material, and therefore very firm adherence can be achieved. As shown in FIG. 2A, by selecting an appropriate light irradiation amount for the patterning material in the vicinity of the mold 104, progress of oxidation (typically photooxidation) can be inhibited and an outstanding mold-release property between the mold and the patterning material can be secured. As a result of leaving a portion which is not photo-oxidized at the interface between the mold and the patterning material, the mold and the patterning material are not adhered to each other and the patterning material can be released from the mold. Therefore, a minute pattern can be formed with a very high yield.

Typical examples of the above-mentioned energy rays include light (visible light, infrared rays, ultraviolet rays), electron beam, and heat. Ultraviolet rays are preferable in the present invention. Ultraviolet rays those wavelength spectrum peak is 365 nm or less are preferable. Specific examples of a source of ultraviolet rays include an ultra-high pressure mercury lamp and a halogen lamp. In one embodiment, when the coating thickness of a patterning material is about 2 μm, the patterning material is irradiated with ultraviolet rays those horizontal emission intensity is 105 μW/cm (wavelength λ=360 nm to 370 nm) for about 3 minutes, thereby vitrification of the patterning material can be performed.

Next, the mold 104 is released from the patterning material 102. As described above, because the oxidation of the patterning material in the vicinity of the mold is inhibited moderately, release of the mold is very easy. Therefore, pattern missing at the time of mold releasing and fall of the yield can be notably inhibited. In addition, as shown in FIG. 1D, when the mold is released, the minute pattern is formed sufficiently favorably in terms of appearance.

As required, the patterning material 102 having a minute pattern formed thereon may be irradiated with oxygen plasma. By the irradiation of oxygen plasma, a sufficient amount of oxygen is supplied to the surface of a patterning material, which has not been completely oxidized. As a result, as shown in FIG. 2B, a hard oxide film is formed on the surface. Thus, deformation of the formed minute pattern is favorably avoided. The thickness of the oxide film formed by plasma treatment is 2 to 3 nm, for example. The irradiation conditions of oxygen plasma are, for example, as follows: oxygen flow of 800 cc, chamber pressure of 10 Pa, irradiation time of 1 minute, and output of 400 W.

Next, as shown in FIG. 1D, the patterning material 102 having a minute pattern formed thereon is irradiated with energy rays (typically ultraviolet rays) from the side opposite to the substrate 100 (i.e., side to which the mold 104 has been contacted by press). By the irradiation of ultraviolet rays, photooxidation of the patterning material in the vicinity of the patterned surface is completed substantially, and the surface of the pattern is sufficiently oxidized (refer to FIG. 2C). In one embodiment, ultraviolet rays may be irradiated in the presence of ozone. By irradiating ultraviolet rays in the presence of ozone, not only that photooxidation reaction caused by the irradiation of ultraviolet rays can be progressed but also the chemical oxidation reaction caused by ozone can be progressed. Thus, oxidation of an unreacted portion of the pattern surface can be favorably completed.

Preferably, after the irradiation of energy rays from the mold side described above, a heat-treatment (a so-called post bake process) can be further performed. By performing a post bake process, oxidation reaction of a polysilane due to heat (thermal oxidation) occurs in addition to the above-mentioned oxidation reaction (photooxidation) of a polysilane by the irradiation of ultraviolet rays. As a result, oxidation of a polysilane is further progressed and a glass having extremely excellent hardness is obtained (refer to FIGS. 1E and 2D). In one embodiment, the conditions of the post bake process are as follows: a heating temperature being preferably 150 to 450° C. and heating duration being 3 to 10 minutes. The heating temperature may vary depending on the purpose. For example, chemical resistance may be imparted to the pattern to be obtained by post baking at 150 to 200° C. It is one of the achievements of the present invention to realize such a post bake process at significantly low temperatures. Moreover, by post baking at 400° C., for example, a pattern which has a Vickers hardness comparable to low-melting point glass can be obtained.

A minute pattern is formed as described above.

### C. APPLICATION OF A MINUTE PATTERN

The minute pattern formed by the method of the present invention may be used suitably for an optical device such as photonic crystals and the like, a micro-channel biochip, a storage device such as patterned media and the like, a replica mold for nanoimprinting, a micro lens, or a display. Hereinafter, typical applications will be described briefly.

### C-1. Three-Dimensional Photonic Crystal

By the application of the minute pattern formation method of the present invention, patterning of any appropriate three-dimensional structure depending on the purpose can be achieved. In the patterning of an organic material, because an organic material is soft, a laminate structure with only several layers may be obtained. On the other hand, in the conventional patterning of an inorganic material, lithography technologies and etching technologies must be combined, which makes it substantially impossible to form a complicated three-dimensional structure. It is one of the achievements of the present invention to enable patterning of a desired (for example, complicated) three-dimensional structure depending on the purpose.

For example, a so-called woodpile photonic crystal can be manufactured by laminating stripe patterns so that the stripe patterns are crossed each other (for example, perpendicularly). A specific procedure for manufacturing a woodpile photonic crystal is as follows: (1) applying a patterning material only onto a convex portion of a pattern of a mold, transferring the pattern to a substrate, and curing the patterning material to form a stripe pattern on the substrate; (2) in the same manner as process (1), forming a stripe pattern on the obtained pattern in such a manner as to be crossed perpendicularly to the obtained pattern; (3) repeating the procedure to thereby obtain a woodpile photonic crystal. Examples of a method of efficiently transferring, to a substrate, only the patterning material applied onto the convex portion of the pattern of the mold include a method of selectively applying a mold release agent only onto the convex portion of the mold. More specifically, PMMA is applied onto an entire surface of a mold, and the mold is subjected to be etched back by oxygen plasma to expose only the neighborhood of the surface of the convex portion. A mold release agent is applied onto the entire surface. Then, by removing PMMA of a concave portion and the mold release agent of the surface thereof, the mold release agent is selectively applied only onto the convex portion of the mold.

### C-2. Biochip

Since a biochip needs to be equipped with a channel, a heater, a driving unit for a liquid to be analyzed, a spectroscopic-analysis means, etc., on a small substrate, it is necessary to form patterns with various sizes and/or shapes at one time. According to the pattern formation method of the present invention, because patterns with various sizes and/or shapes can be formed at one time as described later, any appropriate biochip depending on the purpose can be manufactured. Further, the present invention enables to seal a biochip using a patterning material. As a result, the present invention enables to form a biochip by substantially only using a nanoimprint device instead of using an expensive sealing device. The sealing is performed by, for example, (1) applying a patterning material onto a transparent substrate, and prebaking the resultant to form a laminate of a substrate/a patterning material film, (2) pressing the laminate to a microchannel pattern (biochip), and (3) curing the resultant. The biochip can be sealed without burying the formed microchannel pattern by adjusting the conditions of prebaking and/or pressing.

### C-3. Patterned Media

According to the pattern formation method of the present invention, a patterned media with excellent properties can be manufactured due to favorable patterning properties and favorable glass properties of a pattern to be obtained. As a specific procedure for manufacturing a patterned media, for example, a desired pattern is formed by the above-mentioned pattern formation method of the present invention, a magnetic film is further formed on the pattern, and/or a magnetic domain structure is separated. The formation of the magnetic film is performed by vapor deposition or plating, for example. Separation of the magnetic domain structure is performed by polishing (e.g., CMP) or etching, for example.

### D. INDUSTRIAL APPLICABILITY

The method of the present invention can be used for manufacturing an element and the like which are required to have durability, heat resistance, chemical resistance, mechanical strength, and high aspect ratio. For example, the method of the present invention can be suitably used for forming a minute pattern when manufacturing, for example, an optical device such as photonic crystals, a micro-channel biochip, a storage device such as patterned media, a replica mold for nanoimprinting, a micro lens, and a display.

Hereinafter, the present invention will be described in more detail with reference to Examples, but the present invention is not limited thereto.

### Reference Example 1

### Synthesis of a Polysilane

400 ml of toluene and 13.3 g of sodium were charged in a 1000-ml flask equipped with a stirrer. The temperature of the contents of this flask was increased to 111° C. and stirred at high speed in a yellow room which shielded ultraviolet rays, thereby finely dispersing sodium in toluene. 42.1 g of phenylmethyldichlorosilane and 4.1 g of tetrachlorosilane were added thereto, followed by stirring for 3 hours for polymerization. Then, ethanol was added to the obtained reaction mixture to deactivate excessive sodium. The resultant was washed with water, and then the separated organic layer was put in ethanol to thereby precipitate a polysilane. By re-precipitating the obtained crude polysilane 3 times in ethanol, a branched polymethylphenylsilane having weight average molecular weight of 11,600 and including 10% of oligomer was obtained.

### Reference Example 2

### Preparation of a Patterning Material

The polymethylphenylsilane (PMPS) obtained in Reference Example 1, vinyl group-containing phenylmethylsilicone resin (tradename “KR-2020”, Mw=2,900, iodine value=61), and an organic peroxide BTTB (manufactured by Nippon Oil & Fats Co., Ltd., 20% by weight of solid content) were mixed in proportions shown in Table 2. The resultant mixture was dissolved in methoxybenzene (tradename “anisole S”, manufactured by KYOWA HAKKO KOGYO Co., Ltd.) in such a manner that the solid content was 77% by weight to thereby prepare patterning materials Nos. 1 to 3. In patterning material No. 4, methoxy group-containing phenylmethyl silicone resin not containing a double bond (tradename “DC-3074”, manufactured by Dow Corning Corporation) was used independently. In patterning material No. 5, a double bond-containing silicone compound and methoxy group-containing phenylmethyl silicone resin not containing a double bond were used in combination.

TABLE 2

| | |
|---|---|
| Patterning | Content (% by weight) |

| Material No. | PMPS | KR-2020 | DC-3074 | BTTB |
|---|---|---|---|---|
| 1 | 67 | 33 | 0 | 5 |
| 2 | 50 | 50 | 0 | 3.8 |
| 3 | 40 | 60 | 0 | 3 |
| 4 | 67 | 0 | 33 | 3 |
| 5 | 67 | 16.5 | 16.5 | 3 |

### Example 1

A 5 mm×5 mm sample piece was cut out from a quartz substrate, sufficiently washed, and used as a substrate. Washing was performed by subjecting the sample piece to ultrasonic cleaning in acetone for 3 minutes, and leaving the resultant to stand for 10 minutes in a UV ozone cleaner. Patterning material No. 1 obtained in Reference Example 2 was spin-coated onto the substrate surface for 40 seconds at 2,500 rpm to thereby obtain a coating film with a thickness of about 2 μm. The substrate to which the patterning material was applied was prebaked at 80° C. for 5 minutes.

Subsequently, a mold made of Si on which line and space (L&S) patterns with a plurality of different sizes were formed was pressed against the above-mentioned coating film for 10 seconds at 80° C. at a pressure of 2 MPa for imprinting. In the L&S patterns of the mold used in this example, a line to space ratio L:S was 1:1 and a line (space) size was 250 nm to 25 μm, which differs by two orders of magnitude. Further, ultraviolet rays were irradiated (light source: an ultra-high pressure mercury lamp, output: 250 W, and irradiation time: about 3 minutes) from the substrate side while pressing the mold against the coating film, whereby the coating film was almost completely photooxidized. Subsequently, the mold was pulled up vertically and released. On the surface of the coating film (glass) after the mold was released, the pattern of the mold was favorably reversely transferred.

Further, oxygen plasma treatment was performed to the pattern surface. The conditions of oxygen plasma treatment were as follows: oxygen flow of 800 cc, chamber pressure of 10 Pa, irradiation time of 1 minute, and output of 400 W. Next, ultraviolet rays were irradiated from the pattern surface side (side to which the mold was pressed). This ultraviolet irradiation was performed in the presence of ozone using a UV ozone cleaner. In this process, ultraviolet irradiation was performed for 30 minutes at oxygen flow of 0.5 L/min. Finally, the substrate/the glass pattern obtained as described above was postbaked on a hot plate at 400° C. for 5 minutes. The pattern was formed on the substrate as described above.

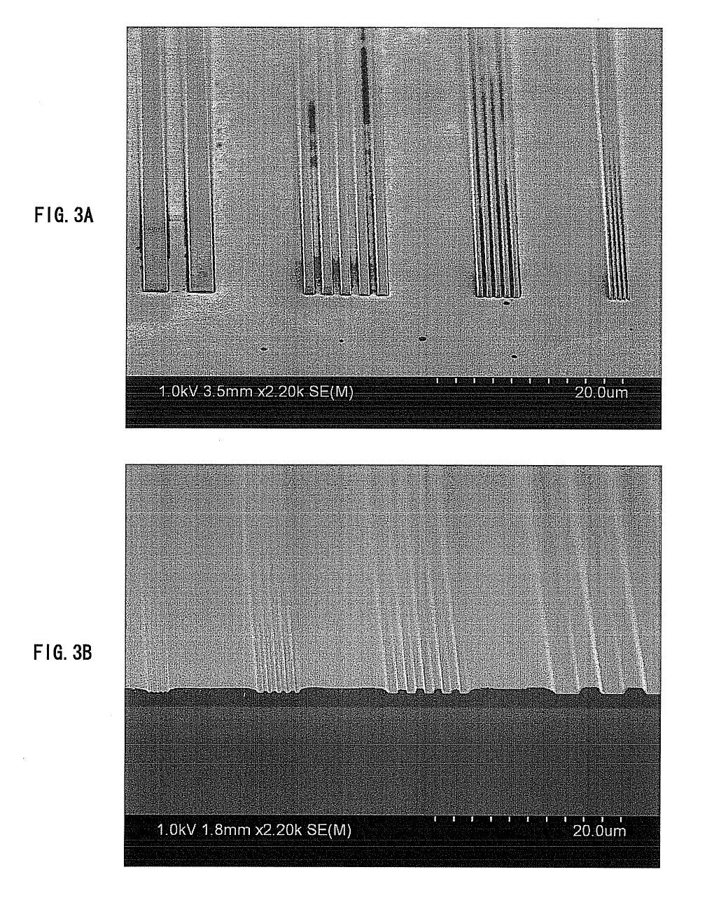

The obtained minute pattern was observed with a scanning electron microscope (SEM). The results are shown in FIGS. 3A and 3B. FIG. 3A is an SEM photograph of the minute pattern of the mold used in the example of the present invention. FIG. 3B is an SEM photograph of the minute pattern obtained in the example of the present invention. As is apparent from FIGS. 3A and 3B, the L&S patterns with a line (space) size of 250 nm to 2.5 μm were favorably imprinted at one time. Further, it was confirmed that the L&S patterns with a line (space) size of 50 nm to 25 μm were favorably transferred under the same conditions as described above, thereby succeeding in collectively forming structures whose sizes differ by about three orders of magnitude. Thus, according to the method of the present invention, it was found that imprinting can be amazingly favorably performed at low temperatures and low pressures, and in a short period of time. Moreover, since low-temperature processing was achieved, a time required for the entire process was notably shortened compared with the conventional process.

Further, the patterning material was evaluated for its properties based on the following evaluation items.

### (1) Heat Resistance

The obtained pattern was heated on a hot plate, and the ratio of the height of the pattern before and after the heat treatment was set as a heat-resistance index. The ratio of the height of the pattern of the pattern obtained in this example after the heat treatment at 250° C. for 5 minutes was 1 (i.e., no deformation was confirmed before and after the heat treatment). Further, the ratio of the height of the pattern after the heat treatment at 350° C. for 5 minutes was 0.95 (thermal contraction was 5%). Thus, the pattern obtained in this example showed outstanding heat resistance.

### (2) Mechanical Properties

After the obtained pattern was baked at 450° C., Micro Vickers hardness was measured as a mechanical property index. The Vickers hardness of the pattern obtained in this example was 310 HV, which was about 3 times as hard as that of PMMA. Thus, the pattern obtained in this example showed an excellent mechanical property (hardness)

### (3) Light Transmittance and Transparency

Transmittance was measured by a usual method. As a result, the visible light transmittance of the pattern obtained in this example was about 90% or higher, and the transmittance of deep ultraviolet rays with a wavelength of 300 nm was 70% or higher. Thus, the pattern obtained in this example had excellent light transmittance not only in a visible region but also in a deep ultraviolet region.

### (4) Chemical Resistance

The obtained pattern was baked 350° C. and then subjected to ultrasonic cleaning in acetone for 5 minutes. The pattern obtained in this example almost completely maintained the shape even after the ultrasonic cleaning.

Moreover, the obtained pattern was immersed in each of an aqueous 10% HCl solution, an aqueous 10% NaOH solution, and an aqueous 5% HF solution for 30 minutes. As a result, the pattern obtained in this example almost completely maintained the shape even after any of the solution treatments. Thus, the pattern obtained in this example had remarkably excellent chemical resistance.

### (5) Aspect Ratio

The aspect ratio was analyzed from an SEM photograph of the obtained pattern. As a result, an aspect ratio of 5 was achieved in the 250 nm L&S pattern. Unlike usual glass, because the patterning material of the present invention is very soft before the ultraviolet irradiation, it was confirmed that a pattern having a still higher aspect ratio can be formed.

### Example 2

The procedure was carried out in the similar manner as in Example 1 except that patterning material No. 2 was used to form a pattern. The obtained pattern was evaluated in the same manner as in Example 1. As a result, as in Example 1, it was confirmed that the obtained pattern was amazingly favorably imprinted, and the pattern obtained in this example had not only excellent hardness and transparency but also outstanding heat resistance, chemical resistance, and aspect ratio.

### Example 3

The procedure was carried out in the similar manner as in Example 1 except that patterning material No. 3 was used to form a pattern. The obtained pattern was evaluated in the same manner as in Example 1. As a result, as in Example 1, it was confirmed that the obtained pattern was amazingly favorably imprinted, and the pattern obtained in this example had not only excellent hardness and transparency but also outstanding heat resistance, chemical resistance, and aspect ratio.

### Example 4

The procedure was carried out in the similar manner as in Example 1 except that patterning material No. 4 was used to form a pattern. The obtained pattern was evaluated in the same manner as in Example 1. As a result, as in Example 1, it was confirmed that the obtained pattern was amazingly favorably imprinted, and the pattern obtained in this example had not only excellent hardness and transparency but also outstanding heat resistance, chemical resistance, and aspect ratio.

### Example 5

The procedure was carried out in the similar manner as in Example 1 except that patterning material No. 5 was used to form a pattern. The obtained pattern was evaluated in the same manner as in Example 1. As a result, as in Example 1, it was confirmed that the obtained pattern was amazingly favorably imprinted, and the pattern obtained in this example had not only excellent hardness and transparency but also outstanding heat resistance, chemical resistance, and aspect ratio.

### Comparative Example 1

In the same manner as in Example 1, a mold was pressed against a patterning material which was applied to a substrate for imprinting. Subsequently, ultraviolet rays were irradiated in the same manner as in Example 1 except that ultraviolet rays were irradiated from the mold side. Subsequently, when the mold was pulled up, the mold and the patterning material were adhered to each other in almost all portions, and thus a pattern was not formed substantially.

### Comparative Example 2

A pattern was formed in the same manner as in Example 1 except that neither oxygen plasma treatment nor ultraviolet irradiation was performed after a mold was released. The obtained pattern was evaluated in the same manner as in Example 1. As a result, collapse of a pattern was observed.

### Comparative Example 3

According to the procedure described in Jpn. J. Appl. Phys., 41, 4198 (2002), a pattern formation was attempted using hydrogen silsesquioxane (HSQ: manufactured by Toray Dow Corning Corporation). The imprinting was performed at 4 MPa and 50° C. An attempt was made to form a similar L&S pattern as that of Example 1 under such conditions. However, a material merely dented slightly and no pattern was formed. Moreover, formation of a pillar-like pattern with a uniform size was attempted, which also ended in failure.

### Comparative Example 4

A pattern formation was attempted using PMMA. The imprinting was performed at 150°, at 4 MPa, and for 10 seconds. Under the conditions, a similar L&S pattern as that of Example 1 was formed. However, when the pattern was baked at 150° C., the pattern disappeared. Moreover, when the obtained pattern was immersed in acetone, the pattern immediately dissolved. Further, the Vickers hardness of the obtained pattern was 100 HV, which was smaller than ⅓ of the Vickers hardness of the pattern of Example 1.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A method of forming a minute pattern, comprising the steps of:
applying, onto a substrate, a patterning material containing a polysilane and a silicone compound;
pressing a mold on which a predetermined minute pattern has been formed to the patterning material which has been applied onto the substrate;
irradiating energy rays from a side of the substrate while the mold is contacted by press with the patterning material;
releasing the mold; and
irradiating the patterning material with energy rays from a side to which the mold has been pressed.

2. A method of forming a minute pattern according to claim 1, further comprising the step of irradiating oxygen plasma after the mold has been released.

3. A method of forming a minute pattern according to claim 1, wherein the step of pressing is performed at around room temperature.

4. A method of forming a minute pattern according to claim 3, wherein the step of pressing is performed with a pressure of 1 to 3 MPa.

5. A method of forming a minute pattern according to claim 1, further comprising the step of heating the patterning material after irradiating the energy rays from the side to which the mold has been pressed.

6. A method of forming a minute pattern according to claim 5, wherein the step of heating is performed at 150 to 450° C.

7. A method of forming a minute pattern according to claim 1, wherein the patterning material has a coating thickness larger than a height of the minute pattern formed on the mold.

8. A method of forming a minute pattern according to claim 1, further comprising the step of heating the patterning material before the step of pressing.

9. A method of forming a minute pattern according to claim 1, wherein the energy rays comprise ultraviolet rays.

10. A method of forming a minute pattern according to claim 1, wherein the step of irradiating energy rays from the side to which the mold has been pressed is performed in the presence of ozone.

11. A method of forming a minute pattern according to claim 1, wherein the patterning material contains the polysilane and the silicone compound at a weight ratio of 80:20 to 5:95.

12. A method of forming a minute pattern according to claim 1, wherein the polysilane comprises a branched polysilane.

13. A method of forming a replica minute pattern to claim 11, wherein the polysilane comprises a branched polysilane.

14. A method of forming a minute pattern according to claim 13, wherein the branched polysilane has a degree of branch of 2% or higher.

15. A method of forming a minute pattern according to claim 1, wherein the patterning material further contains a sensitizer.

16. A three-dimensional photonic crystal, comprising a minute pattern formed by a method according to claim 1.

17. A biochip, comprising a minute pattern formed by a method according to claim 1.

18. A patterned media, comprising a minute pattern formed by a method according to claim 1.
